(19) United States
(12) Patent Application Publication
(10) Pub. No.: US 2015/0134099 A1
(43) Pub. Date: May 14, 2015

(54) WORKPIECE MACHINING DEVICE WITH CALIBRATION FUNCTION AND WORKPIECE MACHINING DEVICE

(71) Applicant: STARTECHNO CO., LTD., Komaki-shi (JP)

(72) Inventors: Tatsumi HISHIKAWA, Ichinomiya-shi (JP); Hirofumi SEGAWA, Kani-shi (JP)

(21) Appl. No.: 14/305,348

(22) Filed: Jun. 16, 2014

(30) Foreign Application Priority Data
Nov. 8, 2013 (JP) 2013-232409
Apr. 10, 2014 (JP) 2014-080615

(51) Int. Cl. G05B 19/402

(52) U.S. Cl. CPC G05B 19/402; G05B 2219/49001
USPC 700/114

(57) ABSTRACT

A workpiece machining device with a calibration function, which is capable of correcting for positioning such that zero points of an industrial robot and a workpiece coincide with each other, is capable of: simplifying a configuration of a workpiece support as compared to when movement of the work support holding the workpiece is controlled for correction to reduce size and cost of the workpiece machining device, and automating positioning work of making the zero points of the workpiece and the industrial robot coincide with each other to achieve labor-saving of work machining work. Three-dimensional machining data is calibrated based on displacement data in X-, Y-, and Z-axis directions computed by a comparison unit to make the zero points of the industrial robot and the workpiece. The industrial robot is then driven and controlled based on the calibrated three-dimensional machining data to perform machining for the workpiece.

### BACKGROUND OF THE INVENTION

1. Field of the Invention

The present invention relates to a workpiece machining device with calibration function and a workpiece machining device that drive and control an industrial robot to perform various machining works such as cutting, drilling, and deburring for a workpiece held by a workpiece support.

More specifically, the present invention relates to a workpiece machining device with calibration function that has function of calibrating (correcting) a zero point of the industrial robot responding to displacement of the workpiece held by the workpiece support and a workpiece machining device.

2. Description of the Related Art

The present inventor has proposed, in Jpn. Pat. Appln. Laid-Open Publication No. 2013-52468, a workpiece support that supports a workpiece when a machining tool mounted to a hand portion of an industrial robot is driven and controlled to perform various operations such as drilling, deburring, and cutting for the workpiece.

In this workpiece support, two workpiece support members adjacently disposed in a longitudinal direction of the workpiece can be positionally adjusted by moving in the front-rear direction orthogonal to the longitudinal direction and left-right direction coinciding with the longitudinal direction, respectively, with respect to other remaining workpiece support members, and can be moved up and down by an identical travel distance by a synchronous vertical drive means, so as to allow mutual intervals between the workpiece support members and heights thereof to be adjusted according to a size of the workpiece and thus to allow the workpiece of various sizes to be held reliably.

In order to perform a desired machining work for the workpiece held by the workpiece support with high accuracy, it is necessary to position, with high accuracy, the workpiece with respect to the workpiece support such that a zero point of the workpiece and a zero point of the hand portion of a work robot coincide with each other. This positioning operation takes much time and effort, degrading machining workability of the workpiece.

Particularly, in order to save labor in machining work for the workpiece, it is necessary to automate supply of the workpiece to the workpiece support. However, operator's visual positioning operation is essential for positioning the workpiece with respect to the workpiece support with high accuracy, which serves an obstacle to the labor-saving in machining work for the workpiece.

The workpiece support of Jpn. Pat. Appln. Laid-Open Publication No. 2013-52468 can control movement of the individual workpiece support members in the longitudinal direction and up-down direction so as to make correction such that the zero point of the industrial robot and that of the workpiece coincide with each other; however, to this end, it is necessary to control movement of the individual workpiece support members with high resolution, disadvantageously complicating a movement mechanism and a movement control device for each workpiece support member, which in turn results in increase in size and cost of the workpiece support.

Problems to be solved are as follows. It takes much time and effort in the positioning operation to be performed to make the zero point of the workpiece coincide with the zero point of industrial robot at machining of the workpiece using an industrial robot, degrading machining workability.

Further, in the case where correction is made such that the workpiece zero point and machine zero point coincide with each other, it is necessary to control movement of the workpiece support member with high resolution, disadvantageously complicating a movement mechanism and a movement control device for each workpiece support member, which in turn results in increase in size and cost of the workpiece support.

Further, operator's visual positioning operation is essential for positioning the workpiece with respect to the workpiece support with high accuracy, which serves an obstacle to the labor-saving in machining work for the workpiece.

### SUMMARY OF THE INVENTION

According to a first aspect of the present invention, a workpiece machining device with calibration function that drives and control an industrial robot based on three-dimensional machining data in X-, Y-, and Z-axis directions stored in a machining data storage area to perform a desired machining work for a workpiece supported by a workpiece support, the workpiece machining device including: a projection unit that projects a reference pattern onto a predetermined portion of the workpiece supported by the workpiece support; an imaging unit that captures the predetermined portion of the workpiece, including the projected reference pattern and outputs the captured imaging data; a storage unit that includes a three-dimensional reference work data storage area that stores three-dimensional data of the workpiece supported by the workpiece support in a normal state, a three-dimensional imaging data storage area that stores three-dimensional imaging data obtained by converting the imaging data captured by the imaging unit into three-dimensional data, and a pattern data storage area that stores pattern data corresponding to the reference pattern to be projected by the projection unit; a comparison unit that compares the three-dimensional imaging data of the predetermined portion including the reference pattern projected onto the predetermined portion of the workpiece supported by the workpiece support and three-dimensional data of the workpiece stored in the three-dimensional reference work data storage area to compute displacement data in the X-, Y-, and Z-axis directions; and a controller that calibrates three dimensional machining data based on the displacement data in the X-, Y-, and Z-axis directions computed by the comparison unit to make a zero point of the industrial robot and a zero point of the workpiece coincide with each other, wherein the industrial robot is driven and controlled based the calibrated three-dimensional machining data to perform machining for the workpiece.

According to a second aspect of the present invention, a workpiece machining device with calibration function that drives and control an industrial robot based on three-dimensional machining data in X-, Y-, and Z-axis directions stored in a machining data storage area to perform a desired machining work for a workpiece supported by a workpiece support, the workpiece machining device including: a two-dimensional moving device mounted to a hand portion of an industrial robot and configured to move a workpiece machining tool having an axis coinciding with a normal line of a machining portion of the workpiece in the X- and Y-axis directions; a projection unit that projects a reference pattern onto a predetermined portion of the workpiece supported by the workpiece support; an imaging unit that captures the predetermined portion of the workpiece, including the projected reference pattern and outputs the captured imaging data; a storage unit that includes a three-dimensional reference work data storage area that stores three-dimensional data of the workpiece supported by the workpiece support in a normal state, a three-dimensional imaging data storage area that stores three-dimensional imaging data obtained by converting the imaging data captured by the imaging unit into three-dimensional data, and a pattern data storage area that stores pattern data corresponding to the reference pattern to be projected by the projection unit; a comparison unit that compares the three-dimensional imaging data of the predetermined portion including the reference pattern projected onto the predetermined portion of the workpiece supported by the workpiece support and three-dimensional data of the workpiece stored in the three-dimensional reference work data storage area to compute displacement data in the X-, Y-, and Z-axis directions; and a controller that drives the two-dimensional moving device based on the displacement data in the X- and Y-axis directions computed by the comparison unit to move the machining tool in the X- and Y-axis directions and calibrates three dimensional machining data in Z-axis direction based on the displacement data in the Z-axis direction to make a zero point of the industrial robot and a zero point of the workpiece coincide with each other, wherein the industrial robot is driven and controlled based the calibrated three-dimensional machining data including the Z-axis direction to perform machining for the workpiece.

According to the present invention, there can be provided a workpiece machining device with calibration function capable of performing correction for positioning such that a zero point of an industrial robot and a zero point of a workpiece coincide with each other with simple operation and in a short time to thereby improve efficiency of a workpiece machining work.

Further, there can be provided a workpiece machining device with calibration function capable of simplifying a configuration of a workpiece support as compared to a case where movement of the work support holding the workpiece is controlled for correction to thereby reduce a size and cost of the workpiece machining device itself.

Further, there can be provided a workpiece machining device with calibration function capable of automating a positioning work of making the zero point of the workpiece and zero point of the industrial robot coincide with each other to thereby achieve labor-saving of a work machining work.

### BRIEF DESCRIPTION OF THE DRAWINGS

FIG. 1 is a perspective view illustrating a schematic outer appearance of a workpiece machining device with calibration function;

FIG. 2 is side view of the workpiece machining device with calibration function;

FIG. 3 is a perspective view of a schematic outer appearance of a two-dimensional moving device;

FIG. 4 is a front view as viewed in a direction of an arrow A of FIG. 3;

FIG. 5 is a side view as viewed in a direction of an arrow B of FIG. 3;

FIG. 6 is an electrical block diagram of a controller;

FIG. 7 is an explanatory view illustrating a state where a workpiece is set to a workpiece support;

FIG. 8 is a flowchart illustrating workpiece machining processing to be performed by an industrial robot;

FIG. 9 is a flowchart illustrating calibration processing;

FIG. 10 is a view illustrating an image of a predetermined portion of the workpiece supported in a normal state;

FIG. 11 is a view illustrating an image of the predetermined portion of the workpiece supported in a displaced state;

FIG. 12 is an explanatory view illustrating a two-dimensional position corrected state.

### DESCRIPTION OF THE PREFERRED EMBODIMENTS

Hereinafter, the present invention will be described based on an embodiment.

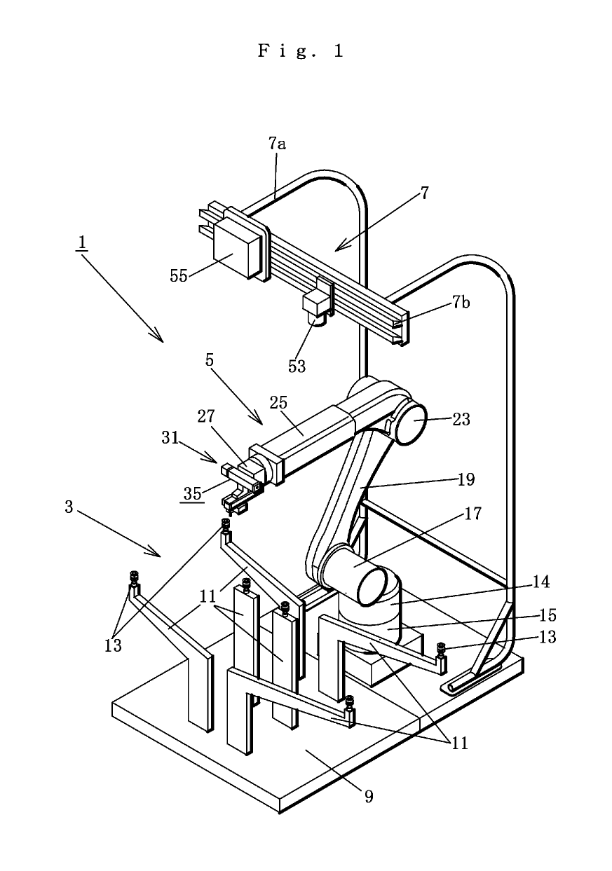

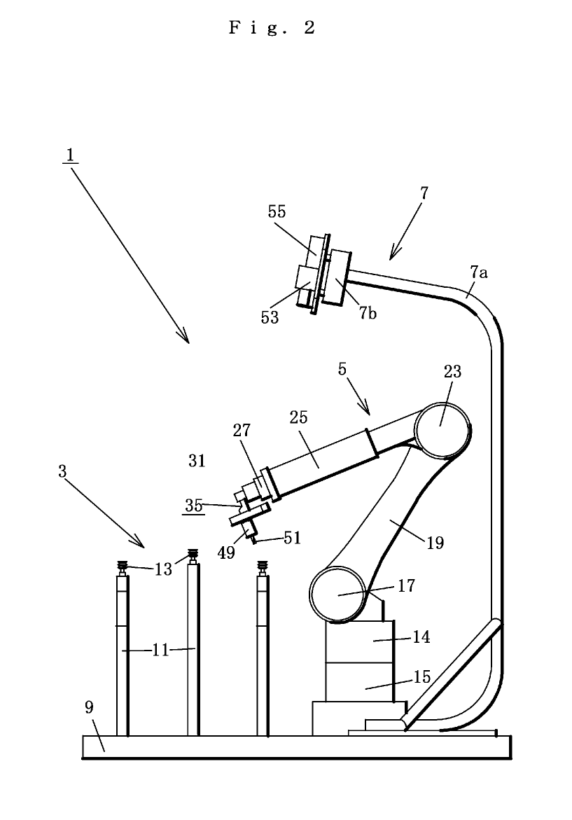

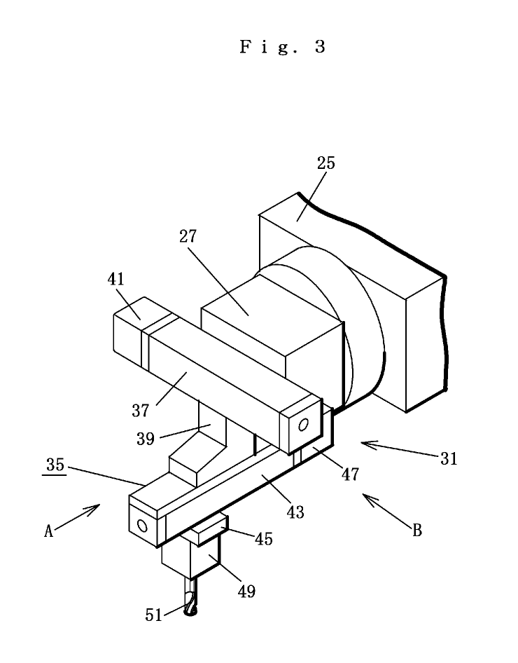

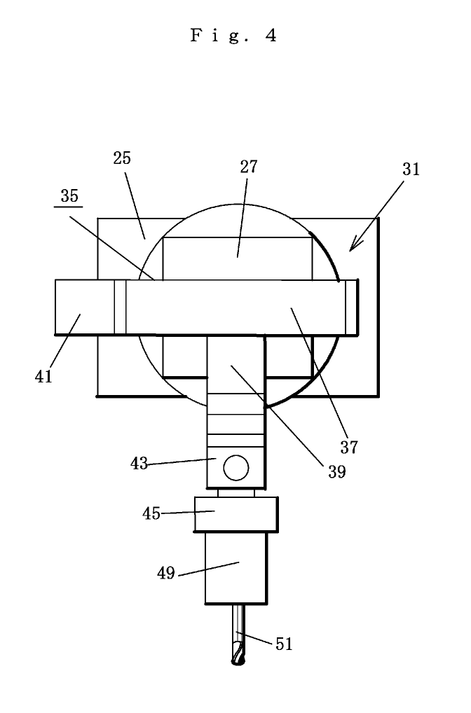

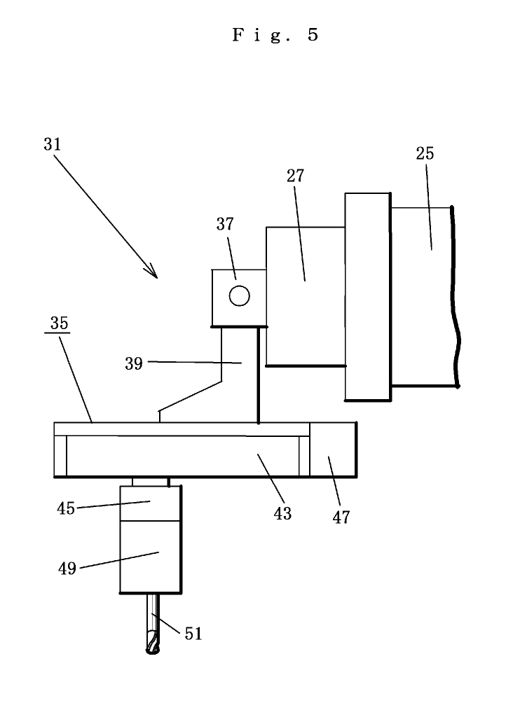

As illustrated in FIGS. 1 to 5, a workpiece drilling device 1 as a machining device with calibration function includes a workpiece support 3, an industrial robot 5, and a calibrator 7.

The workpiece support 3 has a plurality of workpiece support members 11 on a main body frame 9. The plurality of workpiece support members 11 are arranged in a standing manner spaced apart from each other in a left-right direction and a front-rear direction by a predetermined interval so as to correspond to a longitudinal direction (left-right direction) width and a longitudinal orthogonal direction (front-rear direction) width of a workpiece W to be supported. Each workpiece support member 11 has, at its leading end portion (upper end portion) a holding member 13 that holds the workpiece W to be drilled by supporting a rear surface thereof.

Any of the following members may be used as the holding member 13: an elastic member that abuts against the rear surface of the workpiece W to support the workpiece W while regulating displacement by a high friction coefficient; a clamp member having an air cylinder or an electromagnetic solenoid and a grip pawl (all of which are not illustrated) so as to hold a rib (not illustrated) formed in the rear surface of the workpiece W; and an adsorption member (not illustrated) connected to a negative pressure generator to adsorb the rear surface of the workpiece W.

As the workpiece W to be used in the present invention, a metal formed article and a resin formed article such as various types of panel for vehicle or a bumper for vehicle are suitable.

The holding member 13 may be configured to be mounted to a vertical movable body supported by a vertical frame vertically extending from a horizontal movable body supported so as to be movable in the longitudinal direction and longitudinal orthogonal direction of the workpiece W and to move in the left-right direction, front-rear direction, and up-down direction with drive of an electric motor such as numerically controllable servo motor connected to the horizontal and vertical movable bodies to change a support position of the workpiece W.

The industrial robot 5 includes a first arm 19, a second arm 25, a hand mounting member 27, and a hand portion 31. The first arm 19 has a base end portion rotatably supported by a turn table 14 drive-connected to an electric motor (not illustrated) such as numerically controllable servo motor, incorporated in a base 15 and is connected with an electric motor 17 such as numerically controllable servo motor. The second arm 19 has a base end portion rotatably supported by an arm mounting member (not illustrated) connected to an electric motor (not illustrated) such as numerically controllable servo motor, incorporated in a leading end portion of the first arm 19 and is connected with an electric motor 23 such as numerically controllable servo motor. The hand mounting member 27 is connected to an electric motor (not illustrated) such as a numerically controllable servo motor, incorporated in a leading end of the second arm 25. The hand portion 31 is mounted to the hand mounting member 27 and configured to perform drilling for the workpiece W.

The industrial robot 5 may have three or more arms corresponding to the number of rotation shafts and may have, in the base end portion and leading end portion of each arm, the electric motor for rotating a corresponding arm around an axis and in a direction perpendicular to the axis.

The hand mounting member 27 is attached with a two-dimensional moving device 35. The two-dimensional moving device 35 includes a first traveling body 39, a first moving member 41, a second traveling body 45, and a second moving member 47. The first traveling body 39 is supported by a first frame 37 extending in the illustrated left-right direction so as to move in a longitudinal direction of the first frame 37. The first moving member 41 reciprocates the first traveling body 39 in the longitudinal direction thereof. The second traveling body 45 is supported by a second frame 43 mounted to the first traveling body 39 so as to extend in a direction perpendicular to the left-right direction so as to move in a longitudinal direction of the second frame 43. The second moving member 47 reciprocates the second traveling body 45 in the longitudinal direction (direction perpendicular to the left-right direction).

The first and second moving members 41 and 47 may each be of a feed screw moving mechanism that moves the corresponding first traveling body 39 or second traveling body 45 in its predetermined direction with rotation of a feed screw (not illustrated) having an axis in a direction coinciding with the longitudinal direction of the corresponding first frame 37 or second frame 43, rotatably axially supported by an electric motor such as numerically controllable servo motor connected to one end portion thereof, and partially meshing with a nut provided in the corresponding first traveling body 39 or second traveling body 45. Alternatively, the first and second moving members 41 and 47 may each be of a belt moving mechanism that moves a traveling member (belt, not illustrated) wound around rotating bodies rotatably axially supported at longitudinal direction both end portions of the first frame 37 or second frame 43, one of the rotating bodies being rotatably axially supported by an electric motor such as numerically controllable servo motor connected thereto, and partially fixed to the corresponding first traveling body 39 or second traveling body 45 with drive of the electric motor to thereby move the corresponding first traveling body 39 or second traveling body 45 in its predetermined direction.

Further, alternatively, the first and second moving members 41 and 47 may each be of a rack-and-pinion moving mechanism or a linear servo motor having a configuration in which a pinion gear (not illustrated) mounted to an output shaft of an electric motor such as a numerically controllable servo motor provided in the corresponding first traveling body 39 or second traveling body 45 meshes with a rack gear extending in a direction coinciding with the longitudinal direction of the first frame 37 or second frame 43 and thereby moving the corresponding first traveling body 39 or second traveling body 45 in its predetermined direction with drive of the electric motor.

The second traveling body 45 is provided with an electric motor 49, and an endmill 51 as a machining tool for drilling is attached to an output shaft of the electric motor 49. As the machining tool, a cutting blade, a punch blade, a rule blade, a laser beam output head that performs fusion cutting by means of heat energy of output laser beams, and the like can be selectively used according to machining forms of the workpiece W.

A guide rail 7b mounted to a frame 7a of the calibrator 7 is attached with a video camera 53 as an imaging unit and a projector 55 as a projection unit. The video camera 53 and projector 55 are disposed on the guide rail 7b above and spaced apart by a predetermined interval from a predetermined portion of the workpiece W held by the workpiece support 3 and spaced apart by a predetermined interval from each other in the left-right direction. The projector 55 projects various reference patterns such as a slit pattern, a lattice pattern, and a dot matrix pattern around the predetermined portion of the workpiece W. The video camera 53 captures the reference pattern projected around and onto the predetermined portion of the workpiece W and outputs imaging data.

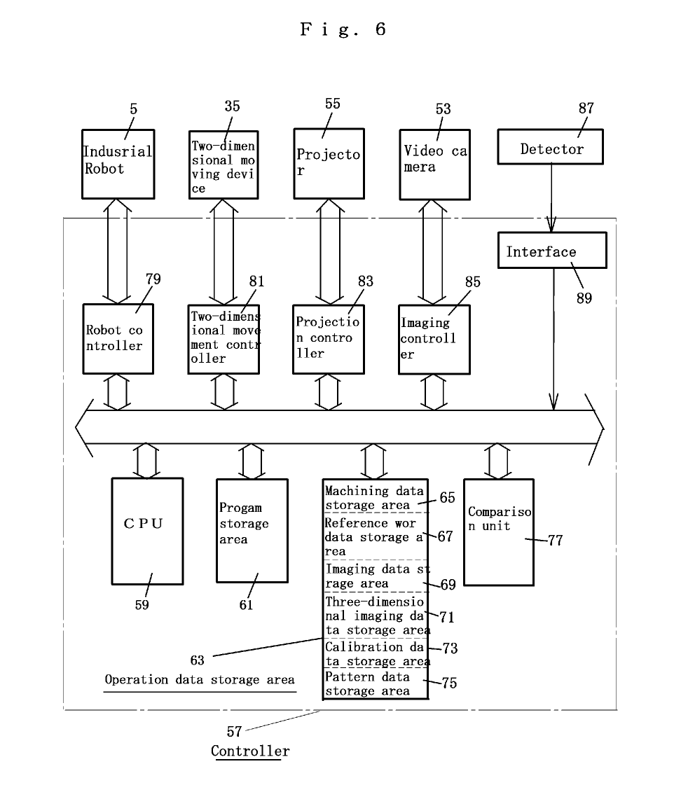

As illustrated in FIG. 6, a CPU 59 of a controller 57 that drives and controls the workpiece drilling device 1 is connected with a program storage area 61 and an operation data storage area 63. The program storage area 61 stores program data for driving and controlling the industrial robot 5 so as to execute drilling for the workpiece W, program data for executing calibration for calibrating the zero point of the workpiece W and zero point of the industrial robot 5.

The operation data storage area 63 includes a machining data storage area 65, a reference work data storage area 67, an imaging data storage area 69, a three-dimensional imaging data storage area 71, a calibration data storage area 73, and a pattern data storage area 75. The machining data storage area 65 stores three-dimensional position data concerning a predetermined moving route (including standby position, machining start point, and drilling position of workpiece W) of the hand portion 31 of the industrial robot 5 and a drilling depth. The reference work data storage area 67 stores three-dimensional reference work data of the workpiece W supported by the workpiece support 3 in a normal state (state where the zero point of the workpiece W and zero point of the industrial robot 5 coincide with each other). The imaging data storage area 69 stores imaging data around the predetermined portion of the workpiece W captured by the video camera 53. The three-dimensional imaging data storage area 71 stores three-dimensional imaging data obtained by converting the imaging data stored in the imaging data storage area 69 into three-dimensional data. The calibration data storage area 73 stores calibration data. The pattern data storage area 75 stores pattern data corresponding to a single or a plurality of patterns to be projected onto the workpiece W.

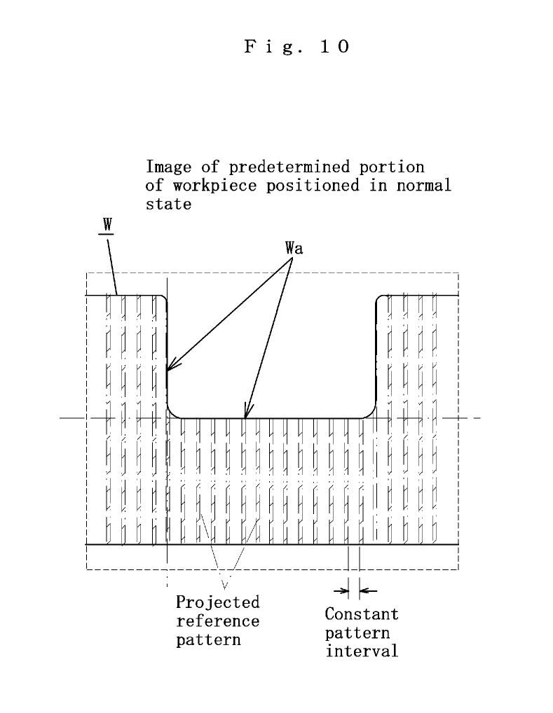

The predetermined portion of the workpiece W to be captured by the video camera 53 desirably includes a reference portion Wa, such as an opening portion, a step portion, or a projecting portion (opening portion, in the case of FIG. 10), serving as a reference for determining two-dimensional displacement. In the absence of the reference portion Wa, reference portions are set for the workpiece support 3 at portions corresponding to both sides of the workpiece W in the longitudinal direction or longitudinal orthogonal direction thereof, and the video camera 53 is used to capture the predetermined portion of the workpiece W, including the reference lines thus set for the workpiece support 3.

The data to be stored in the machining data storage area 65, reference work data storage area 67, and three-dimensional imaging data storage area 71 store the data as world coordinate system data. The reference work data to be stored in the reference work data storage area 67 may be set as the world coordinate system data by directly inputting a three-dimensional position of the workpiece W supported by the workpiece support 3 in the normal state; alternatively, data obtained by synthesizing height data of the workpiece W supported by the workpiece support 3 in the normal state and CAD data of the workpiece W may be set as the world coordinate system data.

The CPU 59 is further connected with a comparison unit 77. The comparison unit 77 compares the three-dimensional imaging data stored in the three-dimensional imaging data storage area 71 and three-dimensional reference work data stored in the reference work data storage area 67, computes a three-dimensional displacement amount as calibration data, and stores the computed calibration data in the calibration data storage area 73.

The CPU 59 is further connected with a robot controller 79. The robot controller 79 drives and controls the not illustrated electric motors and illustrated electric motors 17 and 23 based on the three-dimensional position data stored in the machining data storage area 65 to move the hand portion 31 to the zero point and then to drilling position and executes the drilling.

The CPU 59 is further connected with a two-dimensional movement controller 81. The two-dimensional movement controller 81 drives and controls, when the zero point of the hand portion 31 does not coincide with the zero point of the workpiece W supported by the workpiece support 3, the first and second moving members 41 and 47 based on the calibration data stored in the calibration data storage area 73 to two-dimensionally move the endmill 51 to thereby make the machine zero point and workpiece zero point coincide with each other.

The CPU 59 is further connected with a projection controller 83. The projection controller 83 drives, prior to the drilling to be performed for the workpiece W supported by the work support 3, the projector 55 based on the single or plurality of pattern data read out from the pattern data storage area 75 to project the reference pattern onto a surface corresponding to the predetermined portion of the workpiece W.

In projecting the plurality of reference patterns onto the workpiece W, the projection controller 83 drives the projector 55 for each image capture time (to be described later) of the video camera 53 based on the pattern data read out, in a prescribed order, from the pattern data storage area 75 to project the reference patterns.

The CPU 59 is further connected with an imaging controller 85. The imaging controller 85 drives the video camera 53 for image capture at timing when the reference pattern is projected onto the workpiece W supported by the workpiece support 3 to capture a surface of the workpiece W around the predetermined portion including the reference pattern and then store the captured imaging data in the imaging data storage area 69.

In a case where the plurality of reference patterns are projected onto the workpiece W from the projector 55, the imaging controller 85 drives the video camera 53 for image capture every time the reference pattern to be projected is changed and stores imaging data around the predetermined portion of the workpiece W including the reference patterns in the imaging data storage area 69.

The CPU 59 is further connected, through an interface 89, with a plurality of detectors 87 such as a limit switch that detects a state where the workpiece W is supported by the workpiece support 3. When all the plurality of detectors 87 detects the above state, the CPU 59 determines that the workpiece W is supported by the workpiece support 3 and allows the projector 55 and video camera 53 to perform projection and image capturing, respectively.

The following describes the drilling operation and calibration processing to be performed by the workpiece drilling device 1 having the above configuration.

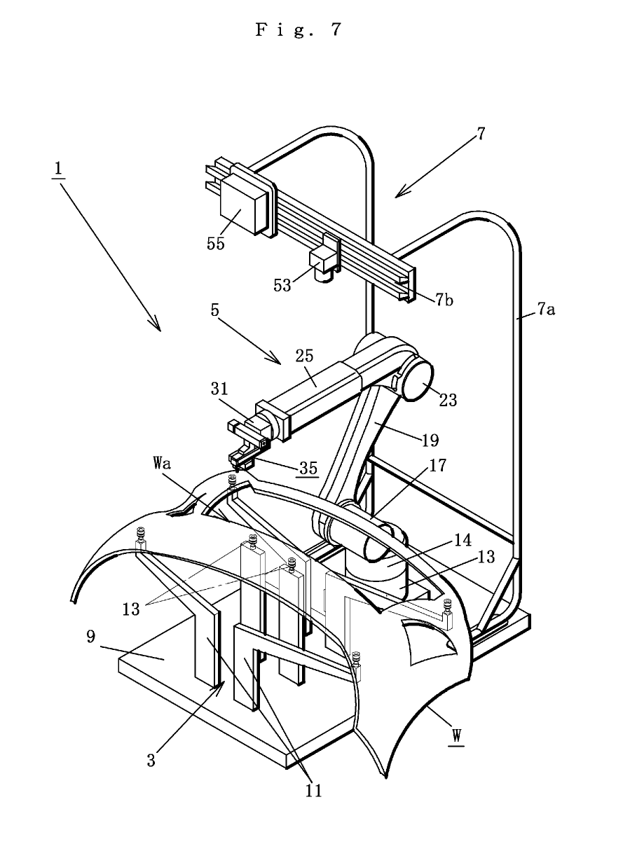

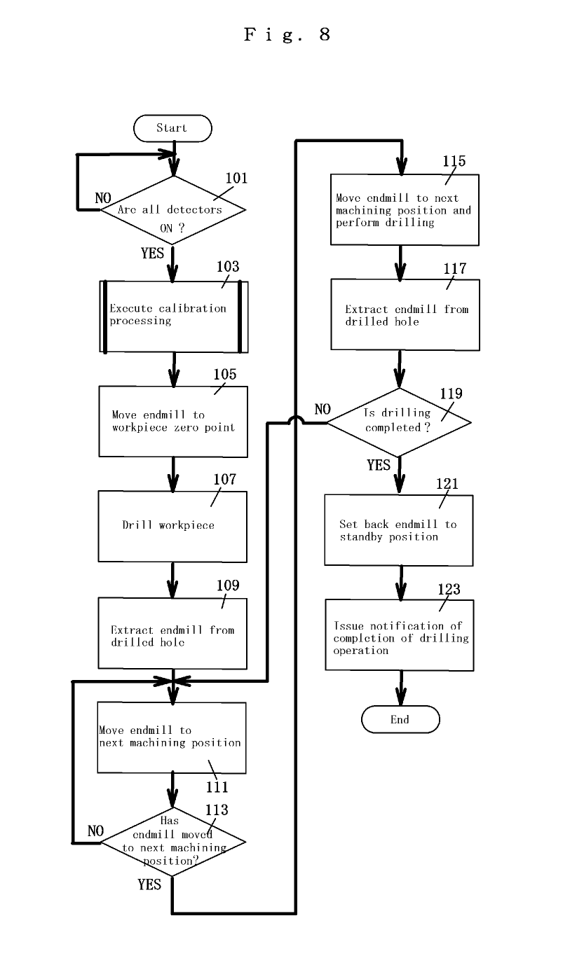

First, an overview of the drilling operation to be performed by the workpiece drilling device 1 will be described. As illustrated in FIG. 8, in step 101, when the workpiece W is set to the workpiece support 3 (see FIG. 7), it is determined whether or not all the detectors 87 are in a workpiece detection state. When a negative determination is made in step 101, the processing flow returns to step 101.

On the other hand, when a positive determination is made in step 101, the calibration processing is executed in step 103 to make the zero point of the industrial robot 5 and zero point of the workpiece W supported by the workpiece support 3 coincide with each other.

Then, in step 105, the not illustrated electric motors and illustrated electric motors 17 and 23 are driven and controlled based on the three-dimensional position data concerning the machine zero point stored in the machining data storage area 65 to swing and rotate the first and second arms 19 and 25, and the hand mounting member 27 is rotated to move the endmill 51 of the hand portion 31 such that an axis of the endmill 51 coincides with a normal line of the zero point of the workpiece W. Subsequently, in step 107, the electric motor 49 is driven to move the endmill 51 based on the three-dimensional position data while rotating the same to thereby drill a hole of a predetermined size and a predetermined depth in the workpiece W.

Then, in step 109, the first and second arms 19 and 25 are swung and rotated based on the three-dimensional position data stored in the machining data storage area 65, and the hand mounting member 27 is rotated as needed to extract the endmill 51 from the drilled hole. Subsequently, in step 111, the first and second arms 19 and 25 are swung and rotated based on the three-dimensional position data stored in the machining data storage area 65, and the hand mounting member 27 is rotated as needed to move the endmill 51 such that the axis of the endmill 51 coincides with a normal line of a next machining position.

Then, in step 113, it is determined whether or not the endmill 51 has moved to the next machining position. When a negative determination is made, the processing flow returns to step 111. On the other hand, when a positive determination is made in step 113, the following operation is performed. That is, in step 115, in the same manner as described above, the electric motor 49 is driven to move the endmill 51 based on the three-dimensional position data while rotating the same to thereby drill a hole of a predetermined size and a predetermined depth in the workpiece W, and, in step 117, the first and second arms 19 and 25 are swung and rotated based on the three-dimensional position data stored in the machining data storage area 65, and the hand mounting member 27 is rotated as needed to extract the endmill 51 from the drilled hole.

Then, in step 119, it is determined whether or not all the machining positions of the workpiece W have been drilled. When a negative determination is made in step 119, the processing flow returns to step 111, where the drilling operation for the next **** is executed.

On the other hand, when a positive determination is made in step 119, the following operation is performed. That is, in step 121, the first and second arms 19 and 25 are swung and rotated based on three-dimensional position data concerning a standby position stored in the machining data storage area 65, and the hand mounting member 27 is rotated as needed to move the hand portion 31 to the standby position, and, in step 123, completion of the machining work is notified by lighting a lamp or issuing a buzzer, and this routine is ended.

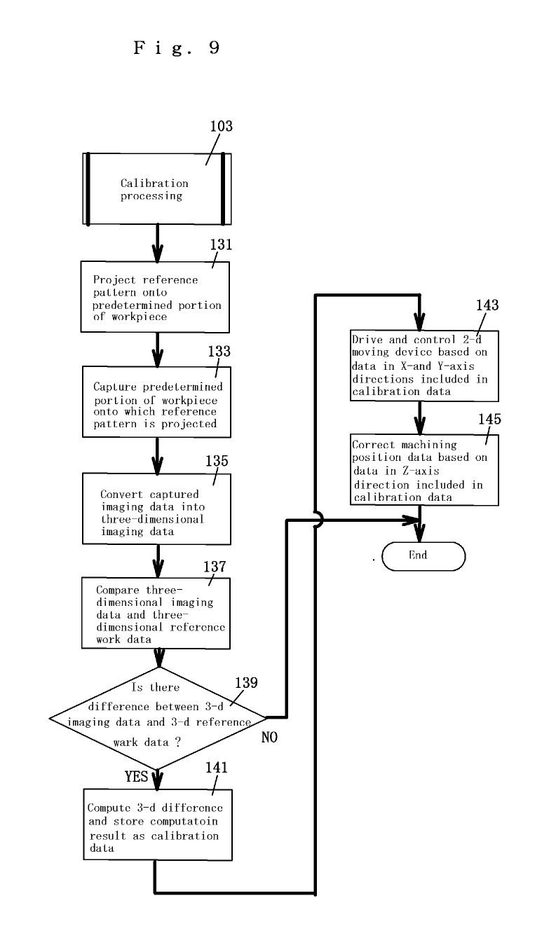

The following describes details of the calibration processing to be performed in step 103. As illustrated in FIG. 9, in step 131, the projector 55 is driven based on the pattern data stored in the pattern data storage area 75 to project the reference pattern onto the predetermined portion of the workpiece W supported by the workpiece support 3. Subsequently, in step 133, the video camera 53 is driven to capture the surface of the predetermined portion of the workpiece W including the projected reference pattern and stores the captured imaging data in the imaging data storage area 69.

In step 135, the imaging data stored in the imaging data storage area 69 is converted into the three-dimensional imaging data, and the obtained three-dimensional imaging data is stored in the three-dimensional imaging data storage area 71. Subsequently, in step 137, the comparison unit 77 compares the three-dimensional imaging data stored in the three-dimensional imaging data storage area 71 and three-dimensional reference work data corresponding to the captured portion stored in the reference work data storage area 67.

In the comparison to be performed by the comparison unit 77, the three-dimensional imaging data of the opening portion Wa and three-dimensional reference work data are compared in terms of two-dimensional position, and a slit interval of the projected reference pattern in the three-dimensional data and a slit interval of the pattern data stored in the pattern data storage area 75 are compared in terms of displacement in the height direction.

Then, in step S139, it is determined whether or not a difference in the pattern data is present between the three-dimensional imaging data and three-dimensional reference work data. When a negative determination is made in step 139, it is determined that the workpiece W is in the normal state with respect to the workpiece support 3 as illustrated in FIG. 10, that is, it is determined that the zero point of the endmill 51 and zero point of the workpiece W coincide with each other, and this routine is ended.

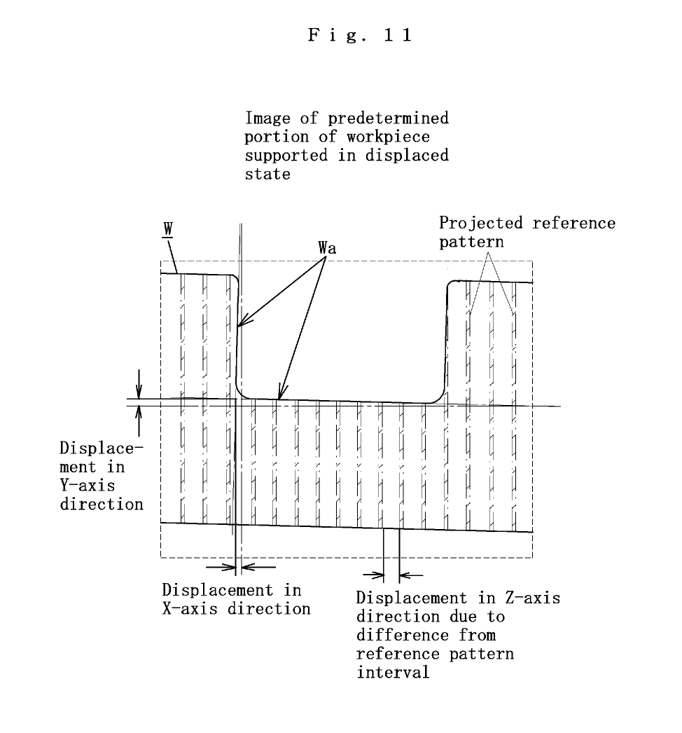

On the other hand, when a positive determination is made in step 139, it is determined that the zero point of the workpiece W supported by the workpiece support 3 and zero point of endmill 51 are displaced from each other as illustrated in FIG. 11. Then, in step 141, a three-dimensional difference is computed, and calculated displacement amount in each of the X-, Y-, and Z-axis directions is stored in the calibration data storage area 73 as the calibration data.

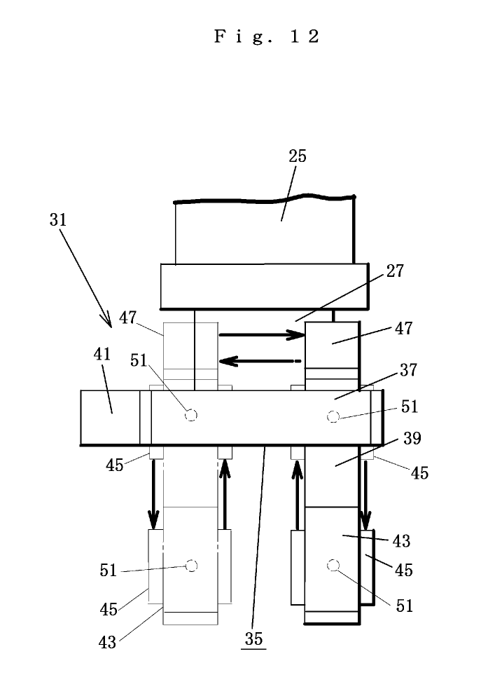

Subsequently, in step 143, the first and second moving members 41 and 47 are driven and controlled based on two-dimensional calibration data in the X- and Y-axis directions included in the calibration data read out from the calibration data storage area 73 to make a leading end (machine zero point) of the endmill 51 coincide with the zero point of the workpiece W (see FIG. 12).

Further, in step 154, Z-axis direction data of the three-dimensional position data concerning the machining position stored in the machining data storage area 65 is corrected using calibration data in the Z-axis direction included in the calibration data read out from the calibration data storage area 73, and the calibration processing is ended.

In the present embodiment, the video camera 55 is used to capture the predetermined portion of the workpiece W including the projected reference pattern after the workpiece W is set to the workpiece support 3, and the three-dimensional imaging data obtained by conversion based on the captured imaging data and three-dimensional reference work data are compared to compute displacement between the zero point of the industrial robot 5 and zero point of the workpiece W. Then, the two-dimensional moving device 35 is driven and controlled based on data in the X- and Y-axis directions included in the computed calibration data to make the zero point of endmill 51 coincide with the zero point of the workpiece W and the three-dimensional machining data is calibrated based on the Z-axis direction data, and the industrial robot 5 is driven and controlled based on the calibrated three-dimensional machining data to perform a predetermined machining work for the workpiece W.

Thus, even when the workpiece W is set to the workpiece support 3 in a non-positioned state, it is possible to perform a desired machining work for a prescribed position on the workpiece W with high quality while reducing time and effort of the positioning work of the workpiece W with respect to the workpiece support 3.

In the above description, the two-dimensional moving device 35 is driven and controlled based on the data in the X- and Y-axis directions included in the computed calibration data to make the zero point of the endmill 51 coincide with the zero point of the workpiece W; however, a configuration may be possible in which the three-dimensional machining data is calibrated based on calibration data in the X-, Y-, and Z-axis directions and the industrial robot 5 is driven and controlled based on the calibrated three-dimensional machining data to make the zero point of the industrial robot 5 and zero point of the workpiece W coincide with each other.

What is claimed is:

1. A workpiece machining device, with a calibration function that drives and controls an industrial robot based on three-dimensional machining data in X-, Y-, and Z-axis directions stored in a machining data storage area to perform a desired machining work for a workpiece supported by a workpiece support, comprising:
a projection unit that projects a reference pattern onto a predetermined portion of the workpiece supported by the workpiece support;
an imaging unit that captures the predetermined portion of the workpiece, including the projected reference pattern and outputs captured imaging data;
a storage unit that includes a three-dimensional reference work data storage area that stores three-dimensional data of the workpiece supported by the workpiece support in a normal state, a three-dimensional imaging data storage area that stores three-dimensional imaging data obtained by converting the imaging data captured by the imaging unit into three-dimensional data, and a pattern data storage area that stores pattern data corresponding to the reference pattern to be projected by the projection unit;
a comparison unit that compares the three-dimensional imaging data of the predetermined portion including the reference pattern projected onto the predetermined portion of the workpiece supported by the workpiece support and three-dimensional data of the workpiece stored in the three-dimensional reference work data storage area to compute displacement data in the X-, Y-, and Z-axis directions; and
a controller that calibrates three dimensional machining data based on the displacement data in the X-, Y-, and Z-axis directions computed by the comparison unit to make a zero point of the industrial robot and a zero point of the workpiece coincide with each other, wherein the industrial robot is driven and controlled based on the calibrated three-dimensional machining data to perform machining for the workpiece.

2. The workpiece machining device with calibration function according to claim 1, wherein:
as the predetermined portion of the workpiece, a portion including a reference portion such as an opening portion, a projection, a projecting portion, or a step portion for use in determination of displacement in the X-axis and Y-axis directions is set; and
based on displacement of the reference portion in the three-dimensional imaging data, displacement in each of the X- and Y-axis directions is detected.

3. The workpiece machining device with calibration function according to claim 1, wherein:
the workpiece support includes reference portions serving as a reference in determination of displacement in each of the X- and Y-axis directions;
a predetermined portion of the work is set between the reference portions; and
based on displacement of a reference portion in the three-dimensional imaging data, displacement in each of the X- and Y-axis directions is detected.

4. The workpiece machining device with calibration function according to claim 2, wherein the imaging data includes the reference portion and the reference pattern projected from the projection unit.

5. The workpiece machining device with calibration function according to claim 1, wherein the three-dimensional data stored in the three-dimensional reference work data storage area is data obtained by synthesizing CAD data of the workpiece and height data of the workpiece supported by the workpiece support.

6. The workpiece machining device with calibration function according to claim 1, wherein the three-dimensional data of the workpiece stored in the three-dimensional reference work data storage area and the three-dimensional imaging data stored in the three-dimensional imaging data storage area are each world coordinate system data.

7. The workpiece machining device with calibration function according to claim 1, wherein the comparison unit computes displacement in the Z-axis direction based on projected pattern data and reference pattern data in the three-dimensional imaging data.

8. A workpiece machining device, with a calibration function that drives and controls an industrial robot based on three-dimensional machining data in X-, Y-, and Z-axis directions stored in a machining data storage area to perform a desired machining work for a workpiece supported by a workpiece support, comprising:
a two-dimensional moving unit mounted to a hand portion of an industrial robot and configured to move a workpiece machining tool having an axis coinciding with a normal line of a machining portion of the workpiece in the X- and Y-axis directions;
a projection unit that projects a reference pattern onto a predetermined portion of the workpiece supported by the workpiece support;
an imaging unit that captures the predetermined portion of the workpiece, including the projected reference pattern and outputs captured imaging data;
a storage unit that includes a three-dimensional reference work data storage area that stores three-dimensional data of the workpiece supported by the workpiece support in a normal state, a three-dimensional imaging data storage area that stores three-dimensional imaging data obtained by converting the imaging data captured by the imaging unit into three-dimensional data, and a pattern data storage area that stores pattern data corresponding to the reference pattern to be projected by the projection unit;
a comparison unit that compares the three-dimensional imaging data of the predetermined portion including the reference pattern projected onto the predetermined portion of the workpiece supported by the workpiece support and three-dimensional data of the workpiece stored in the three-dimensional reference work data storage area to compute displacement data in the X-, Y-, and Z-axis directions; and
a controller that drives the two-dimensional moving unit based on the displacement data in the X-, Y-, and Z-axis directions computed by the comparison unit to move the machining tool in the X- and Y-axis directions and calibrates three dimensional machining data in Z-axis direction based on the displacement data in the Z-axis direction to make a zero point of the industrial robot and a zero point of the workpiece coincide with each other, wherein the industrial robot is driven and controlled based on the calibrated three-dimensional machining data including the Z-axis direction to perform machining for the workpiece.

9. The workpiece machining device with calibration function according to claim 8, wherein:
as the predetermined portion of the workpiece, a portion including a reference portion such as an opening portion, a projection, a projecting portion, or a step portion for use in determination of displacement in the X- and Y-axis directions is set; and
based on displacement of the reference portion in the three-dimensional imaging data, displacement in each of the X- and Y-axis directions is detected.

10. The workpiece machining device with calibration function according to claim 8, wherein:
the workpiece support includes reference portions serving as a reference in determination of displacement in each of the X- and Y-axis directions;
a predetermined portion of the work is set between the reference portions; and
based on displacement of the reference portion in the three-dimensional imaging data, displacement in each of the X- and Y-axis directions is detected.

11. The workpiece machining device with calibration function according to claim 9, wherein the imaging data includes the reference portion and the reference pattern projected from the projection unit.

12. The workpiece machining device with calibration function according to claim 8, wherein the three-dimensional data stored in the three-dimensional reference work data storage area is data obtained by synthesizing CAD data of the workpiece and height data of the workpiece supported by the workpiece support.

13. The workpiece machining device with calibration function according to claim 8, wherein the three-dimensional data of the workpiece stored in the three-dimensional reference work data storage area and the three-dimensional imaging data stored in the three-dimensional imaging data storage area are each world coordinate system data.

14. The workpiece machining device with calibration function according to claim 8, wherein the comparison unit computes displacement in the Z-axis direction based on projected pattern data and reference pattern data in the three-dimensional imaging data.

15. A workpiece machining device, that drives and controls an industrial robot based on three-dimensional machining data in X-, Y-, and Z-axis directions stored in a machining data storage area to perform a desired machining work for a workpiece supported by a workpiece support, comprising, in a hand portion of the industrial robot, a two-dimensional moving unit that moves a workpiece machining tool in the X- and Y-axis directions, wherein:
in a state where the hand portion is set to a machining position of the workpiece by drive of the industrial robot, the machining tool is moved in the X- and Y-axis directions by drive of the two-dimensional moving unit.

16. The work machining device according to claim 15, wherein the two-dimensional moving unit comprises:
a first traveling body reciprocably supported by a first frame provided at a leading end of an arm so as to extend in the X-axis direction or Y-axis direction;
a first moving member that reciprocates the first traveling body in the extending direction of the first frame;
a second traveling body supported by a second frame mounted to the first traveling body so as to extend in a direction perpendicular to the first frame and attached with the machining tool; and
a second moving member that reciprocates the second traveling body in the extending direction of the second frame.

17. The workpiece machining device with calibration function according to claim 3, wherein the imaging data includes the reference portion and the reference pattern projected from the projection unit.

18. The workpiece machining device with calibration function according to claim 10, wherein the imaging data includes the reference portion and the reference pattern projected from the projection unit.
